(19) United States
(12) Patent Application Publication
(10) Pub. No.: US 2013/0275913 A1
(43) Pub. Date: Oct. 17, 2013

(54) Presentation of Items on a Display

(71) Applicants: Simon MORITZ, Stockholm (SE); Anders L. Johansson, Upsala (SE); Filip Stenbeck, Gustavsberg (SE); Stefano Zappaterra, Genova (IT)

(72) Inventors: Simon MORITZ, Stockholm (SE); Anders L. Johansson, Upsala (SE); Filip Stenbeck, Gustavsberg (SE); Stefano Zappaterra, Genova (IT)

(73) Assignee: Telefonaktiebolaget L M Ericsson (pub), Stockholm (SE)

(21) Appl. No.: 13/446,365

(22) Filed: Apr. 13, 2012

(51) Int. Cl. G06F 3/048

(52) U.S. Cl. 715/810

(57) ABSTRACT

A user terminal in a group of user terminals for which interaction statistics concerning items are provided in an interaction data server and being associated with an entity identifier administrated by an entity handling server, comprises a user input unit, a display, a communication interface, an item memory comprising a set of items, an entity memory with the entity identifier and an item presentation control unit configured to fetch the entity identifier, request entity specific data from the entity handling server, receive the entity specific data, obtain interaction statistics regarding items in the set from the interaction data server, determine priorities of the items in the set based on the interaction statistics and the entity specific data, select a group of items from the set based on their priority settings and the size of the display, and present the group of items on the display.

### TECHNICAL FIELD

The invention relates to presenting of items on the displays of user terminals. More particularly, the invention relates to a method, communication device and computer program product for simplifying a selection of items of interest.

### BACKGROUND

Applications, have become popular to download into user terminals such as into communication devices.

There may exist countless such applications that can be provided in the device. Applications are typically presented to the user via items, such as icons representing them. These items can normally not all be presented on the display of the user terminal, which leads to some kind of navigation mechanism having to be employed.

It is known to use gestures for navigation purposes. A user may here enter gestures directly onto a touch screen and these gestures may then be used for scrolling, panning and zooming activities. This enables the presentation of a large number of items on a limited size display. The use of gestures for unlocking of a device is described in US 2009/0241072.

However, it is still hard for a user to locate the items that are of potential interest.

There have been developed systems that use usage patterns and user contact in hiding items for a user in a computer. One such use in relation to stationary computers is described in EP 1505496.

It is thus known to use usage patterns of a user to select what items to present. In this way items that are of interest for a user will be presented first, which is of advantage when there are many such items.

There is a problem in that upon an initial use of a user terminal, there is no usage pattern. However, there is still an interest to present items that are of potential interest to the user.

There is therefore a need for improvement in this field of technology.

### SUMMARY

The invention is therefore directed towards improving the ease of access to items of interest in a new user terminal.

One object of the invention is thus to simplify the selection of items of interest presented on a new user terminal.

This object is according to a first aspect of the invention achieved through a method for simplifying a selection of items of interest presented on a user terminal. The items are provided in a set of items in the user terminal. The user terminal has a display and is a user terminal in a group of user terminals for which interaction statistics concerning items is provided in an interaction data server. The user terminal is also associated with an entity identifier administrated by an entity handling server. The method comprises fetching the entity identifier, requesting entity specific data linked to the entity identifier from the entity handling server, receiving the entity specific data as a response to the request, obtaining interaction statistics from the interaction data server, determining priorities of the items in the set based on the interaction statistics and the entity specific data, selecting a group of items from the set based on their priority settings and the size of the display, and presenting the group of items on the display.

The object is according to a second aspect of the invention achieved through a communication device for simplifying a selection of items of interest on a display of the communication device. The communication device is a user terminal in a group of user terminals for which interaction statistics concerning items are provided in an interaction data server. The communication device is also associated with an entity identifier administrated by an entity handling server The communication device comprises a user input unit for receiving user selections, the display for presenting items of interest to the user, a communication interface, an item memory comprising a set of items, an entity memory with the entity identifier and an item presentation control unit. The item presentation control unit is in turn configured to fetch the entity identifier, request entity specific data linked to the entity identifier from the entity handling server via the communication interface, receive said entity specific data as a response to the request, obtain interaction statistics regarding the items in the set from the interaction data server via the communication interface, determine priorities of the items in the set based on the interaction statistics and the entity specific data, select a group of items from the set based on their priority settings and the size of the display and present the group of items on the display.

The above-mentioned object is according to a third aspect of the invention solved through a non-transitory computer program product for simplifying a selection of items of interest presented on a user terminal. The items are provided in a set of items in the user terminal. The user terminal has a display and is a user terminal in a group of user terminals for which interaction statistics concerning items is provided in an interaction data server. The user terminal is also associated with an entity identifier administrated by an entity handling server. The computer program product comprises computer program code, to make the user terminal execute, when the program code is loaded in the user terminal: fetch the entity identifier, request entity specific data linked to the entity identifier from the entity handling server, receive the entity specific data as a response to the request, obtain display size data, obtain interaction statistics regarding the items in the set from the interaction data server, determine priorities of the items in the set based on the interaction statistics and the entity specific data, select a group of items from the set based on their priority settings and the size of the display, and present the group of items on the display.

The invention has many advantages. It provides fast and simple access to items that a user may like even though the device is used for the first time.

The entity specific data may comprise historic data related to the entity. The entity specific data may also or alternatively comprise data concerning the current context of the entity.

The entity may the user. As an alternative the entity may be the user terminal.

The communication device may be a portable communication device. As such it may also be a cellular phone.

According to a first variation of the invention, the method further comprises obtaining position data about the physical position of the user terminal and determining priorities also based on the position data.

According to the first variation the item presentation control unit of the communication device is further configured to obtain position data about the physical position of the communication device and to determine priorities also based on the position data.

According to a second variation of the invention, the priorities are dynamically updated based on receiving updated interaction statistics from the interaction data server in the method.

According to the second variation of the invention, the item presentation control unit of the communication device is configured to dynamically update the priorities based on receiving updated interaction statistics from the interaction data server.

According to a third variation of the invention, the method further comprises determining a primary item, where the determining of priorities of the items in the set comprises determining relations between the items based on the interaction statistics and on the entity specific data, where each relation between an item and the other items in the set comprises a priority setting, the selecting of a group of items comprises selecting a first number of secondary items from the set having relations to the primary item, where the first number of secondary items are selected based on the priority setting with regard to the primary item and the size of the display, and the presenting of the group of items comprises presenting the primary object on the display together with the first number of secondary items.

According to the third variation of the invention, the item presentation control unit of the communication device is configured to determine a primary item, to determine relations between the items based on the interaction statistics when determining priorities, where each relation between an item and the other items in the set comprise a priority setting, to select a first number of secondary items from the set having relations to the primary item when selecting a group of items, where the first number of secondary items are selected based on the priority setting with regard to the primary item and the size of the display, and to present the primary object on the display together with the first number of secondary items when presenting the group of items.

The first number of secondary items may furthermore be the items with the highest priorities that fit on the display.

The user selections may comprise a user selection of an item being presented.

According to a fourth variation of the invention, the method comprises receiving this user selection and the determining of a primary item is based on this selection. According to the fourth variation of the invention, the item presentation control unit of the communication device is configured to determine the primary item based on the user selection.

The dependency of the secondary items to the primary item may furthermore be coded into the presentation. Also the priority settings of the first number of secondary items may be coded into the presentation.

According to a fifth variation of the invention, the method further comprises receiving the user selection and updating the priority settings associated with the item based on this user selection.

According to the fifth variation of the invention, the item presentation control unit of the communication device is configured to update the priority settings associated with the item based on the user selection.

The user selection may be a selection of the primary item.

According to a sixth variation of the invention, the method then comprises launching an application associated with the primary item or presenting statistics of the primary item based on this user selection.

According to the sixth variation of the invention, the communication device comprises an item handling unit. Here the item presentation control unit is configured to order the item handling unit to launch an application associated with the primary item or present statistics of the primary item based on the user selection.

The user selection may be a user selection of presentation of further secondary items in the set.

According to a seventh variation of the invention, the method then comprises selecting a second number of secondary items to be presented based on the user selection.

According to the seventh variation of the invention, the item presentation control unit of the communication device is configured to select a second number of secondary items to be presented based on this user selection.

The user selections may be received via a gesture and the second number of secondary items may be selected based on the length of the gesture. The gesture may also be received via the display. In this case the user input unit and display of the communication device may be combined into a touch screen.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The invention will now be described in more detail in relation to the enclosed drawings, in which:

FIG. 1 schematically shows a number of user terminals a an interaction data server, an application provider, as well as an entity handling server connected to a communication network,

FIG. 2 shows a simplified block schematic of one of the user terminals that is a communication device,

FIG. 3 shows a flow chart of a method according to a first embodiment of the invention,

FIG. 4 shows a flow chart of a number of method steps in a first part of a method according to a second embodiment of the invention,

FIG. 5A shows a first variation of presenting a primary item with secondary items on a display of the communication device,

FIG. 5B shows a second variation of presenting a primary item with secondary items on the display of the communication device,

FIG. 5C shows a third variation of presenting a primary item with secondary items on the display of the communication device,

FIG. 6A shows a view depicting the selection of a new primary item when there exists a previous primary item,

FIG. 6B shows a modified view when the newly selected item has become a primary item,

FIG. 6C schematically indicates the moving of items on a display caused by the selection of an item,

FIG. 7 shows a flow chart of a number of method steps in a second part of a method according to the second embodiment of the invention, and

FIG. 8 schematically shows a computer program product according to an embodiment of the invention in the form of a CD ROM disc.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary detail.

The invention is generally directed towards presenting of items on a display of a communication device. Here an item can be a graphical symbol such as an icon for an application. However, the item may also represent other types of information such as electronic documents, media files or even hardware like microphones and speakers. In one variation of the invention each item represents a package or item of food in a cupboard or refrigerator with which the communication device is associated. In another variation the items may represent the components of a car, such as engine, gear box etc. The items thus represent elements, which elements may be documents, applications or physical objects. The item may also be regarded as a data indicator providing one or more data sets, where such a data set may be of interest to a user of the communication device. The item could represent an application for the device, and may also be used for launching the application. Through actuating the item, the corresponding application may thus be started.

The invention is more particularly directed towards presenting a limited number of items on the display of the communication device in order to enhance the possibility for the user to easily discern between and navigate through items of various relevance to him or her.

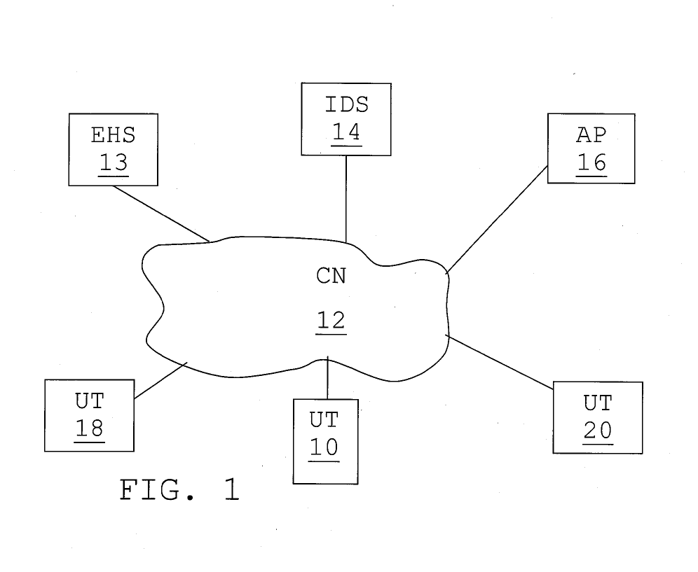

The invention will now be described in more detail in the non-limiting example context of a communication network CN 12 that may be a WAN (Wide Area Network). The network 12 is shown in FIG. 1. This network 12 may here be a cellular network such as an UMTS (Universal Mobile Telecommunications System) network or an LTE (Long Term Evolution) network. However it may also be a landline network. The invention is actually not limited to wide area networks, but may in fact be realized without the use of such networks. To the network 12 there is connected a number of user terminals UT 10, 18 and 20, where a first of these user terminals 10 is a communication device according to the invention. The communication device 10 is in the present example a portable communication device in the form of a cellular phone. A cellular phone is merely one example of a communication device with which the invention may be used. Other types of communication devices, portable and stationary, are computers, like a PC (Personal Computer) and laptop and/or palmtop computers, and electric organizers. The communication terminal 10 may communicate with an interaction data server IDS 14, an application provider AP 16, as well as with an entity handling server EHS 13. All these are thus also connected to or a part of the communication network 12. In one variation of the invention the entity handling server 13 is a unit handling communication identifiers, such as phone number and communication subscriptions for users of the communication network 12. In this variation the entity handling server 13 is a home location register (HLR).

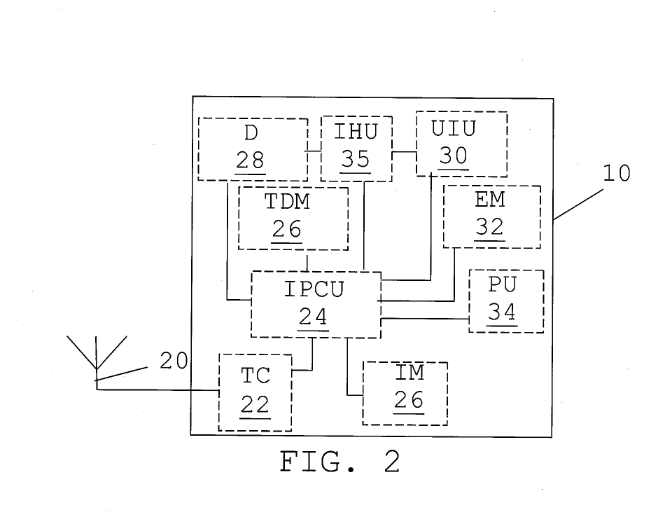

FIG. 2 schematically shows units of the communication device 10. The communication device 10 comprises a communication interface, which in one variation of the invention is made up of an antenna 20 together with a transceiver circuit TC 22. The transceiver circuit 22 is connected to an item presentation control unit IPCU 24. This item presentation control unit 24 is in turn connected to an item memory 26, to an entity memory EM 32, to a terminal data memory TDM 26, to a display D 28, to a user input unit UIU 30 and to an item handling unit IHU 35. Here the item handling unit 35 is also connected to the display 28 and user input unit 30. Finally there is a positioning unit 34 being connected to the item presentation control unit 24. It should be realized that the positioning unit 34 is optional. It should also be realized that the terminal data memory 26 is optional. All the units, memories and the display are furthermore depicted as dashed boxes within the communication device 10.

The communication device 10 will in the following be described in the non-limiting example of a cellular phone to which software in the form of applications, so called Apps, may be downloaded from the application provider 16. However applications may also be pre-stored in the communication device 10. The items, here icons, representing these applications are as an example stored in the item memory 26 of the communication device 10. The item store thus comprises a set of items that are associated with corresponding applications.

It is possible that the number of items being provided will be considerable. The number of such applications has increased considerably. A communication device may therefore comprise several applications, and all of them are typically represented by an item on the display of the communication device.

The size of communication devices is furthermore becoming smaller and smaller, which means that the amount of items that are being present on a display is limited. In order to see what applications are actually possible to select, the numbers have to be small. This means that the number presented is a very limited subset of the total amount of items in the set.

At the same time a user typically has favourites among the applications or there exist applications that are likely favourites. It would be of interest to present these first to a user, so that he or she will not have to perform extensive searches in order to find an application of interest.

There have been developed systems to present possible items of interest to a user when there exists a multitude of items. In for instance the Internet based web shops it is common for a customer selecting a certain product to get suggestions about other products purchased by other customers. This means that a user looking at an item will get suggestions about other items that other user have looked at. Such systems typically provide a server where data about the use or interest of items are stored with regard to a group of users. The interaction data server 14 in FIG. 1 is such a server. In the interaction data server 14 statistics that can be employed according to this technique is kept for a group of user terminals in the communication network with regard to applications. This means that the interaction data server keeps statistics of the interactions of user terminals, for instance as a group, here exemplified by the three user terminals 10, 18 and 20 with regards to applications. These interactions may be statistics of usage patterns such as web sites visited and communication techniques used. From such interaction statistics it is then possible to obtain preferences of these users as a collective, such as the applications that are most popular as well as perhaps the order in which such applications are used by such a group.

This is a good tool that can be used in order to select items to be presented to a user of the communication device. However, a user is an individual with his or her special preferences. This means that items that the user him or herself is interested in may get neglected because a majority of the users have other preferences.

This can be addressed through weighting the selections of items in favour of those made by the user via the communication terminal. In this way a user may after time obtain a communication device where the items being presented are the ones most often selected by him or her.

There is one problem with this approach and that is that when a user first uses a communication device there exist no customisation to this user. A lot of items may be presented that are not of interest to the user.

It would be more satisfying for the user to be able to see items that are of potential interest to him or her from the start. This would also allow the user to more quickly access the items of interest to him or her from the start, even though there is no such prior knowledge in the communication device about the user.

The present invention is directed towards this problem, namely the problem of providing a “personalized” entry point to a vast number of applications for a new user of the communication device.

In one variation of the invention this concept is taken one step further and provides the foundation of a new way of navigating through items.

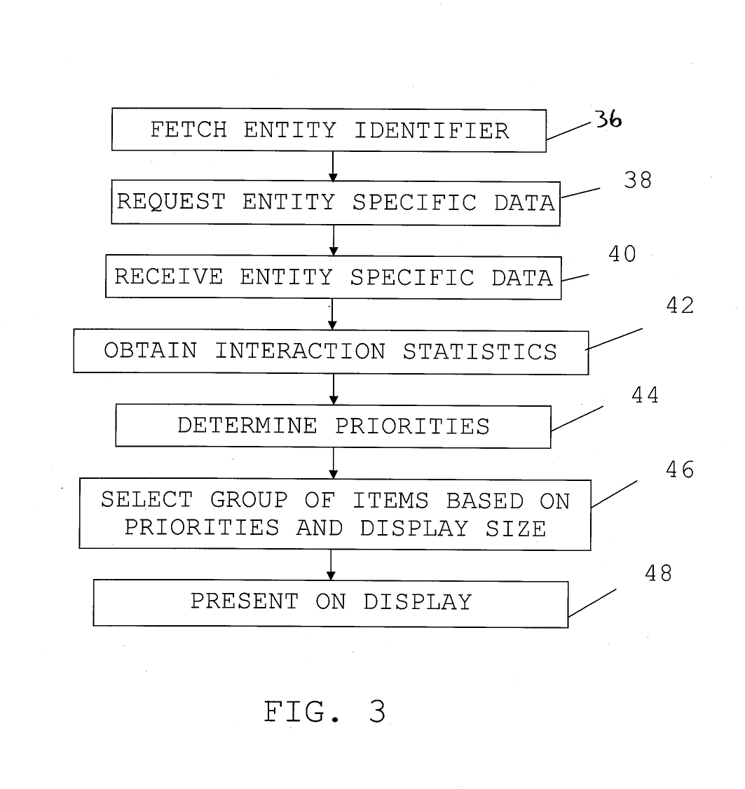

Now the functioning of the first embodiment of the invention will be described in more detail with reference being made to the previously described FIGS. 1 and 2 as well as to FIG. 3, which shows a flow chart of a number of method steps being performed in this method according to the first embodiment.

The method starts with the item presentation control unit 24 fetching an entity identifier from the entity memory 32, step 36. The entity identifier may be an e-mail address of the user, such as a gmail id, a user id or a Mobile Subscriber ISDN Number (MSISDN). The identifier may thus be an identifier associated with the user. Because of this the entity memory 32 may be a removable memory such as a Subscriber Identity Module (SIM) card. When the item presentation control unit 24 has received the entity identifier, it then sends a request for entity specific data to the entity handling server 13, step 38. This request is typically sent via the communication interface made up by the transceiver circuit 22 and antenna 20. The request for entity handling data may here also be a request for entity handling data concerning the elements that the items are linked to.

The entity handling server 13 may be a server in which the identity identifier is administrated. In the example of MSISDN, the entity handling server 13 is a HLR. The entity handling server then collects entity specific data and sends this data to the communication device 10. The entity specific data may here be historic data of activities of the entity performed using the entity identifier. In this case the entity may be the user. Such data may comprise data accessing other servers, such as Uniform Resource Locators (URL) or IP addresses. These may identify the frequency of which some applications have been used as well as the order of use of some applications. Such activities have then been performed by the user via another user terminal. The entity specific data may also be used to determine the current context of the communication device, such as position, available communication techniques, possible congestion in the communication network etc. Entity specific data may also comprise demographic data about the user. If there is a subscription of the user linked to an entity identifier. Such a subscription may in turn be linked to more dara about the user like demographics.

The item presenting control unit 24 thus receives the entity specific data via the communication interface, step 38, and thereafter obtains interaction statistics, step 42.

This is done through the item presentation control unit 24 connecting to the interaction data server 14 and requesting interaction statistics, which request is also sent via the communication interface 22 and 20. The request for interaction statistics may be a request for statistics only concerning activities related to the items or to the elements represented by the items. In the case of the items representing applications, then the request may be a request for statists of interactions in relation to these applications.

The interaction data server then collects interaction statistics concerning a group of users, here exemplified by the two terminals 18 and 20. These statistics may comprise data about the visiting of web sites where functionalities of the application are provided and the number of uses of applications. Such use may be possible to detect if an application communicates with an application server. The interaction statistics can also comprise the number of downloads of the applications by the users. It may also comprise the order of use or download. This data is then typically associated with the items by a whole collection of users.

The interaction statistics is then received by the item presentation control unit 24 which then proceeds and determines priorities, step 44. In order to determine priorities the item presentation control unit may analyse the interaction statistics and determine the relevance of it for elements associated with the items. If the elements are applications, it may then be possible to determine the applications that are most poplar by the whole group, which later application is used after a prior application etc. Such data may then be used for determining priorities. In this first embodiment this determination of priorities may only comprise giving each item a priority, i.e. a ranking between the items. This ranking is then based on the collected interaction statistics as well as on the entity specific data. If it is for instance possible to discern applications used by the user in the entity specific data, then these may receive a higher priority than the other applications only being used by the other user terminals in the group. This can also be seen as providing weights to the items, where these weights reflect the ranking. Thereafter the item presentation control unit 24 selects a group of items, step 46. This selection is made based on the priorities but also on the display size. The item presentation control unit 24 may here have existing knowledge of the display size. In case it does not it may fetch display size data from the terminal data memory 26. It thus selects a group of items from the item memory 26, for instance items having the highest priorities, and then presents them on the display 28, step 48. The group is here thus limited by the display size.

One item, for instance the one deemed to have the highest priority, may also be selected to be or assigned as a primary item. This may be presented as being larger than the others. It may be presented in such a way that it's dominant role is evident. This may be done through presenting it in the centre of the display. In the first embodiment all the highest ranked items, i.e. the ones having the highest priorities, are presented together independently of each other. It is possible to vary this through presenting the primary item with other items, secondary items, having a higher probability for being selected after the primary item and in this way being linked to the primary item. This principle will be described in relation to the second embodiment of the invention.

It can here be seen that it is possible to present a number of items according to the probability that they are to be used by the user of the communication device. This is furthermore done without having to use the communication device a number of times for obtaining this particular collection. This simplifies the locating of items of interest to the user and also enhances the experience of use of the communication device

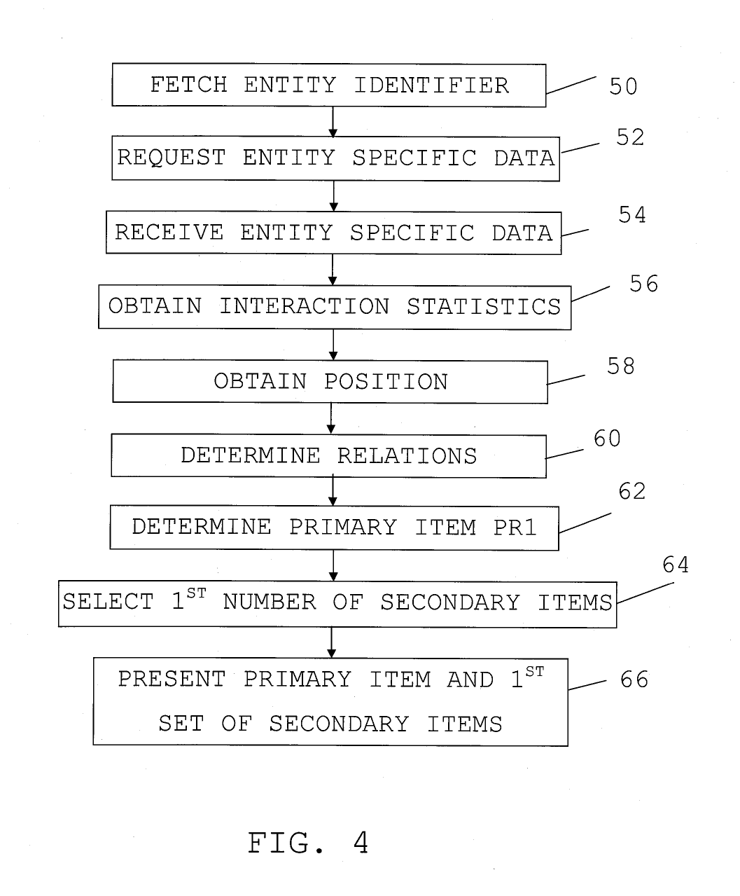

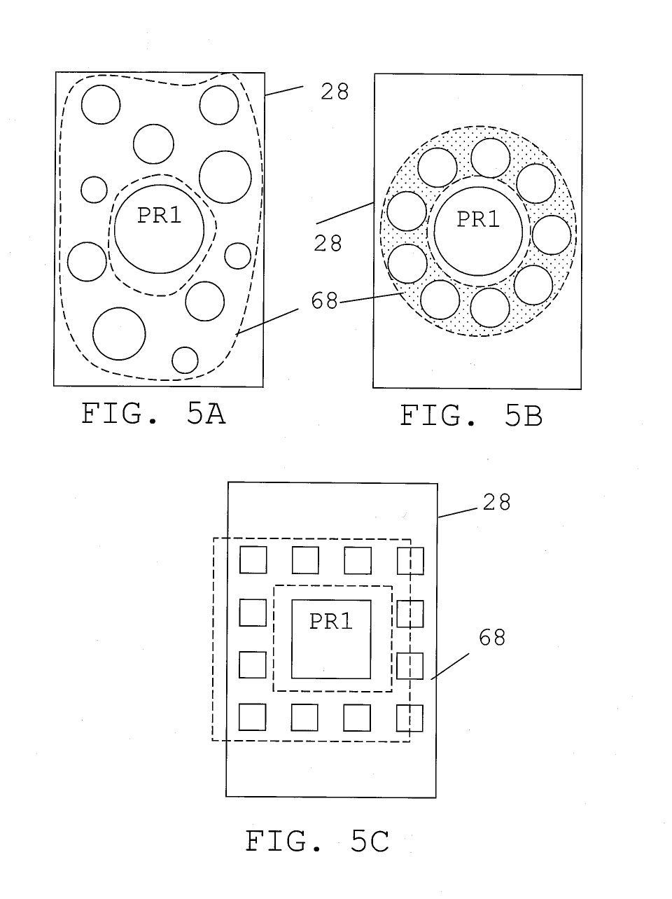

A first part of a second embodiment will now be described with reference being made to FIGS. 1 and 2 as well as to FIGS. 4, 5A, 5b and 5C, where FIG. 4 shows a flow chart of a number of method steps in the first part of the method, FIG. 5A shows a first variation of presenting a primary item with secondary items on a display of the communication device, FIG. 5B shows a second variation of presenting a primary item with secondary items on the display of the communication device and FIG. 5C shows a third variation of presenting a primary item with secondary items on the display of the communication device.

Just as in the first embodiment, this second embodiment starts with the item presentation control unit 24 fetching an entity identifier from the entity memory 32, step 50. When the item presentation control unit 24 has received the entity identifier, it then sends a request for entity specific data to the entity handling server 13, step 52, receives the entity specific data via the communication interface, step 54, and thereafter obtains interaction statistics, step 56. All of these activities may be performed in the same way as in the first embodiment. In this embodiment the item presenting control unit 24 also obtains the physical position of the communication device 10, step 58. Also the position can be considered to be context data of the communication device. The position may be obtained from the positioning unit 34, which may be a Global Position System (GPS) positioning unit in contact with a positioning satellite. As an alternative it is possible to obtain the position from the communication network 12. The communication network may determine the position, for instance using triangulation employing a number of base stations.

Based on this data, position (which is optional), entity specific data and interaction statistics, the item presentations control unit 24 then determines relations between the items. Each relation between an item and the other items in the set will in this determination comprise a priority setting. This means that if one item is first investigated, then this investigated item may have a relation to every other item in the set. The investigated item will thus have a relation to every other item in the item memory 26. Each such relation will then receive a priority setting. The priority setting of a relation will then reflect the probability that the item at the other end of the link will be selected next after the investigated when the investigated item is presented. Every item in the set may be investigated in this way in order to obtain relations to it from the other items in the set. Every item in the item memory may thus be investigated in this exercise. In the determining of priority settings then all above mentioned data, entity specific data, interaction statistics and position may be considered. It is here also possible that a threshold is used, i.e. that some relations are not created or given priority settings since the probability of them being selected are too low. It is in the same way possible that some of the items are never investigated as primary items in this determining of relations.

Thereafter the item presenting control unit 24 determines a primary item, step 62. In this embodiment the primary item is determined through selecting one of the items for which relations have been determined to be primary item, for instance the one having the highest priority without a relation, i.e. a general priority just as in the first embodiment. As an alternative it is possible that the items with highest general priorities are presented and then the primary item is determined based on receiving a user selection of the item via the user input unit 30.

After the primary item has been determined, the item presenting control unit 24 selects a first number of secondary items, step 64. In this embodiment this selection is a selection of the secondary items having links with the highest priority settings while at the same time considering the display size. The number of secondary items may thus depend on the available screen space around the primary item. Thereafter the item presentation control unit presents the primary item PR1 together with the first set of secondary items on the display 28, step

Three different ways in which this can be done is shown in FIGS. 5A, 5B and 5C, which show the primary item PR1 together with the first number 68 of secondary items on the display 28.

The primary item PR1 is displayed in such a way that it's dominant role is clear. The secondary items in the first number if secondary items are displayed in such a way that their inferior role is clear. This means that the dependency of the secondary items to the primary item is coded into the presentation. This can be done through presenting the primary item in the centre of the display with the secondary items surrounding it. Alternatively the primary item may be presented on the top of the display with the secondary items below it. It is also possible to present a larger primary item than secondary items. It is furthermore possible to use colours, shading and highlighting techniques to code the dependency into the presentation. In FIGS. 5A and 5B, the items have an exemplifying circular shape. Here the primary item PR1 is bigger than the secondary items in order to clarify it's distinction. In FIG. 5A the priorities and here the priority settings are also coded into the presentation. This has been done through the secondary items having higher priority settings being larger than the secondary items having lower priority settings. It is also possible to place secondary items with higher priority settings closer to the primary item than the secondary items with lower priority settings.

The order, position and the size of the secondary item may thus depend on the priority setting existing to the primary item. If there exists a sorting order among the secondary items, for example the most popular items related to the primary items in popularity order, the top related item may thus be shown bigger and closer to the primary item than the less related one.

In FIG. 5B no such distinction is made between the secondary items but they are placed regularly around the primary item.

FIG. 5C shows an example that is similar to the example in FIG. 5B but with rectangular items.

This concludes the first part of the method according to the second embodiment.

The primary item PR1 and the first number 68 of secondary items can be selected. The view showing these can also be starting point for further navigations among the items.

The user can interact with the whole interface, by clicking or making gestures. The user may for instance click on the primary item, in which case more details about the item may be shown. The user may also click on any secondary item. This makes it become the new primary item. This would lead to the relations with priority settings of this new primary item being presented and all the new secondary items according to their relationship with the new primary item being recalculated. Therefore clicking on any secondary item in sequence may result in navigating item to item. The user can also make gestures to navigate item to item. Here it is also possible to navigate backwards. Every time secondary items are being presented with a current primary item. It is possible to present a link back to a previous primary item.

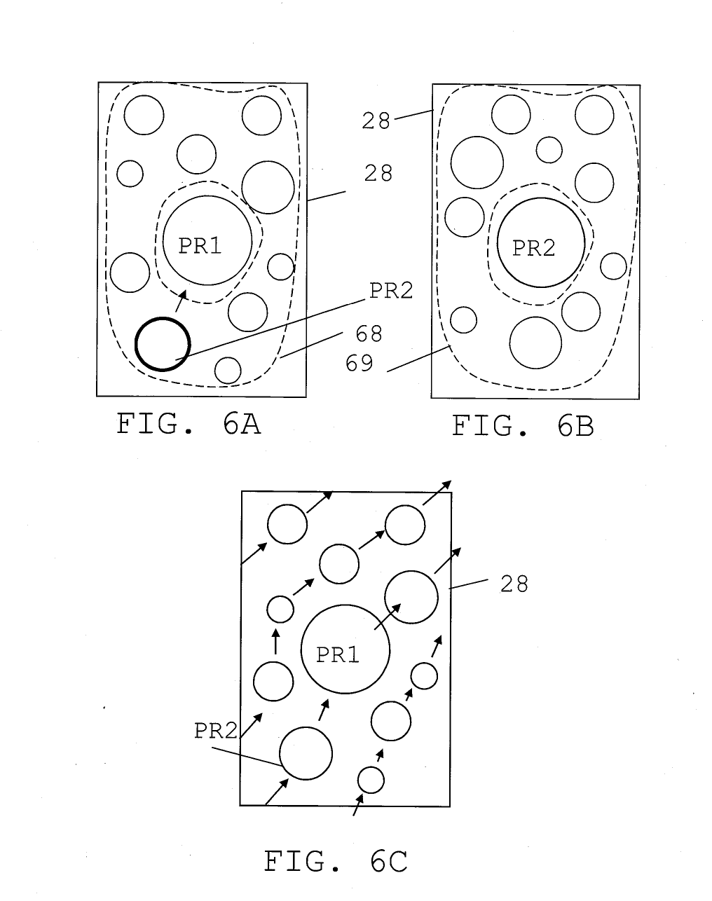

It is thus possible to use the technique described above for navigation purposes. Some of the possible situations are schematically shown in FIGS. 6a, 6B and 6C, where FIG. 6A shows the selection of a new primary item PR2, FIG. 6B shows a modified view when the newly selected item PR2 has become a primary item and FIG. 6C schematically indicates the moving of items on the display caused by the selection of the new primary item.

Clicking on a secondary item may thus have the meaning of making it become the new primary item PR2 instead of the former primary item PR1. When this action is selected by the user, some transitions take place. The former primary item PR1 may disappear or transition out of view and the selected secondary item PR2 move or transition to the location of the old primary item PR1, as can be seen in FIGS. 6A and 6B. Alternatively the old primary item may be retained as a back step option. The old first number of secondary items 68, i.e. the ones associated with the first primary item PR1, may disappear through also transitioning out of the view and a different or new first number 69 of secondary items may appear or transition in.

Here it is possible that a transition-out may have the item simply disappear without moving, or move outside the screen. A transition-in may have the item appear without moving, or entering in from the outside of the screen. A transition-move may have the item move to the place of another item, and resize it to get the destination item size.

The user can also make gestures to select an item to become the primary one. The selected secondary item may be dragged to the centre in the place of the old primary item. During the dragging phase, the secondary item may follow the user's finger, and all other items will move accordingly so that at the end of the dragging, the item con FIGuration will be achieved. This type of scenario is indicated in FIG. 6C.

During dragging, some items may move to another item place, some items may move outside of the area, some items may move in from the outside of the area.

At the end of the dragging operation, the new conFIGuration of the item will be reached.

Here it may also be mentioned that it is also possible to show the items as objects on a map, where the parts of the map shown may be determined by the position of the communication device 10.

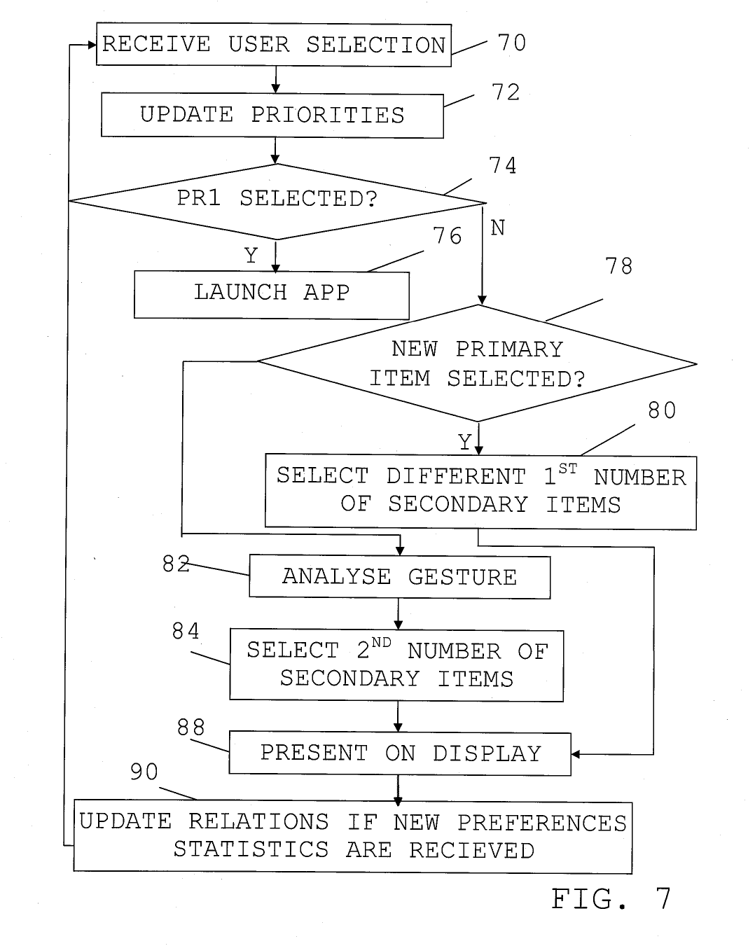

The second part of the operation according to the second embodiment can also be described in the following way, with reference being made to FIG. 7, which shows a flow chart of a number of method steps in the second part of the method according to the second embodiment.

The item presentation control unit 24 here receives a user selection via the user input unit 30, step 70. The type of user selection is then investigated. In this second embodiment there are three possible exemplifying user selections, a selection of the primary item, a selection of a secondary item to be new primary item and a selection of further navigation. After this investigation the relations or priorities are then updated based on the user selection, step 72. If the primary item PR1 is selected the general priority of this item may be changed, for instance raised. The priority setting to a possible previously shown primary item may also be changed such as raised. If the user selection concerns the selection of a new primary item PR2, the relation between the former primary item PR1 and this latter primary item PR2 as secondary item may be raised, perhaps without changing the general priority of this selected item. A user selection of further navigation among secondary items may also influence the priority settings.

The item presenting control unit 24 then performs various activities based on what the user selection was. If the user selection is a selection of the primary item PR1, step 74, then the item presentation control unit 24 orders the item handling unit 35 to launch the application associated with the item, step 76. It may as an alternative order the item handling unit to display further data about the item. It may alternatively itself display such further data. The selection may also lead to the item handling unit presenting the primary item on a map, for instance at a position on the map occupied by the communication device.

However, if the user selection was not the selection of the primary item, step 74, but instead the selection of a new primary item PR2, step 78, then a different first number 69 of secondary items is selected, i.e. the items having the relations with the highest priority settings to this new primary item PR2. This new first number of secondary items and the new primary item PR2 are then presented on the display 28, step 88.

If however the user selection was no selection of primary item, step 74 and step 78, then it was a selection of a second number of secondary items. The item presentation control unit 24 therefore analyses the gesture, step 82, and based on this analysis it may then select the second number of secondary items, step 84. The gesture may be a so-called “fling” in which case the second number may merely be the following number of slightly lower priority setting. As an alternative the gesture may have a certain length and then it is possible that the length of the gesture indicates how far away in terms of priority setting the items in the second number of items are from the first number of items. There are countless other ways to obtain the second number of secondary items. A user may for instance employ a “pinch” gesture. If the user pinches in, when the first number of secondary items are being displayed, the first number of secondary items could collapse to the centre and disappear, and the second number of secondary items with lower priority enter from the outside. This pinch in is similar to a zooming operation. Another alternative is to use a scrolling type of operation, where the secondary items are presented as concentric rings or rectangles. A ring or rectangle with the first number of secondary items would then be replaced by a concentric ring or rectangle with the second number of secondary items.

After selection, then presentation is then made on the display, step 88. In the presentation it may be possible to navigate back to a view where the former primary item PR1 is again primary item. There may thus be provided an order of previous primary items that it is possible to step back to in order to view their corresponding associated secondary items.

The item presenting control unit 24 may continuously monitor the interaction data server 14. Therefore, after presentation of the items the relations between the items may be updated if new interaction statistics are received from the interaction data server 14, step 90. The item presentation control unit 24 may thus dynamically update the priorities based on the reception of updated interaction statistics from the interaction data server.

After this possible updating the item presentation control unit 24 returns and waits for user selections, step 70.

This second embodiment has the same advantages as the first embodiment. However it does also have some further advantages. It provides access to items having relations to each other in a simple manner. It also simplifies and speeds up the navigation through the item space towards items that the user likes. The second embodiment thus provides a simple and user-friendly interaction with the items. It is easy to understand the flow, i.e. what is happening, as well as possible to quickly access content of an item that one may like. The interaction is also suitable for cold start problem, presenting a few items that one may like and then enable the user to select the navigation path that may interest him or her more. The invention thus provides information about and simple and easy access to preferred candidates for items to use after a certain item has been selected. This second embodiment thus provides an improved navigation through the items where every selection of a primary item leads to the presenting of the most likely desirable candidates of a following primary item. This means that the number of uninteresting items will be reduced leading to a quicker and more satisfactory navigation. At the same time infrequently desired items may easily be selected with only a few simple user inputs.

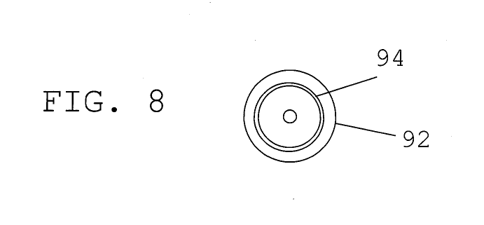

The item presentation control unit may with advantage be provided in the form of a processor with associated program memory including computer program code for performing the functionality of this unit. It should be realized that this unit may also be provided in the form of hardware, like for instance in the form of an ASIC circuit. The computer program code may also be provided on a data carrier, like a CD ROM disc or a memory stick, which comprises such computer program code that will implement the function of the item presentation control unit when being loaded into a user terminal. One such computer program product in the form of a CD ROM disc 92 with this computer program code 94 is schematically shown in FIG. 8.

Also the item handling unit may be provided as a processor with associated program memory and code. The user input unit may be a keyboard or a key pad. It may also be combined with the display in a touch screen. The positioning unit may be a GPS positioning unit and the memories may be RAM, ROM or even flash memories.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the invention is only to be limited by the following claims.

1. A communication device for simplifying a selection of items of interest, said communication device being a user terminal in a group of user terminals for which interaction statistics concerning items are provided in an interaction data server and being associated with an entity identifier administrated by an entity handling server, the communication device comprising:
a user input unit for receiving user selections;
a display for presenting items of interest to the user;
a communication interface;
an item memory comprising a set of items;
an entity memory with the entity identifier; and
an item presentation control unit configured to:
fetch the entity identifier,
request entity specific data linked to the entity identifier from the entity handling server via the communication interface,
receive said entity specific data as a response to the request,
obtain interaction statistics regarding the items in the set from the interaction data server via the communication interface,
determine priorities of the items in the set based on the interaction statistics and the entity specific data,
select a group of items from the set based on their priority settings and the size of the display, and
present said group of items on the display.

2. The communication device according to claim 1, wherein the entity specific data comprises historic data related to the entity.

3. The communication device according to claim 1, wherein the entity specific data comprises data concerning the current context of the entity.

4. The communication device according to claim 1, wherein the item presentation control unit is further configured to obtain position data about the physical position of the communication device and to determine priorities also based on the position data.

5. The communication device according to claim 1, wherein the item presentation control unit is configured to dynamically update the priorities based on receiving updated interaction statistics from the interaction data server.

6. The communication device according to claim 1, wherein the item presentation control unit is further configured to determine a primary item, to determine relations between the items based on the interaction statistics when determining priorities, where each relation between an item and the other items in the set comprise a priority setting, to select a first number of secondary items from the set having relations to the primary item when selecting a group of items, where the first number of secondary items are selected based on the priority setting with regard to the primary item and the size of the display, and to present the primary object on the display together with the first number of secondary items when presenting the group of items.

7. The communication device according to claim 6, wherein the first number of secondary items are the items with the highest priorities that fit on the display.

8. The communications device according to claim 6, wherein the user selections comprise a user selection of an item being presented and said item presentation control unit is configured to determine the primary item based on this user selection.

9. The communication device according to claim 6, wherein the dependency of the secondary items to the primary item is coded into the presentation.

10. The communication device according to claim 6, wherein item presentation control unit is further configured to code the priorities of the first number of secondary items into the presentation of them.

11. The communication device according to claim 6, wherein said user selections comprises a selection of an item presented on the display and the item presentation control unit is configured to update the priority settings associated with this item based on this selection.

12. The communication device according to claim 6, further comprising an item handling unit, where the user selection is a selection of the primary item and the item presentation control unit is further configured to order the item handling unit to launch an application associated with the primary item or present statistics of the primary item based on the user selection.

13. The communication device according to claim 6, wherein the user selections comprise a user selection of presentation of further secondary items in the set and the item presentation control unit is configured to select a second number of secondary items to be presented based on this user selection.

14. The communication device according to claim 13, wherein said user selection is received via gestures and the second number of secondary items is selected based on the length of the gesture.

15. The communication device according to claim 14, wherein the user input unit and display are combined into a touch screen and the gesture is received via this touch screen.

16. The communication device according to a claim 1, wherein the entity is the user or the user terminal.

17. The communication device according to claim 1, wherein it is a portable communication device, such as a cellular phone.

18. A method for simplifying a selection of items of interest presented on a user terminal having a display, wherein the user terminal is a user terminal in a group of user terminals for which interaction statistics concerning items is provided in an interaction data server, the method comprising:
fetching an entity identifier associated with a user terminal, the entity identifier being administered by an entity handling server;
requesting entity specific data linked to the entity identifier from the entity handling server;
receiving said entity specific data as a response to the request;
obtaining interaction statistics from the interaction data server;
determining priorities of items in a set of items based on the interaction statistics and the entity specific data;
selecting a group of items from the set of items based on their priority settings and the size of the display, and
presenting said group of items on the display.

19. A non-transitory computer program product for simplifying a selection of items of interest presented on a user terminal, said items being provided in a set of items in said user terminal, the user terminal having a display and being a user terminal in a group of user terminals for which interaction statistics concerning items is provided in an interaction data server and being associated with an entity identifier administrated by an entity handling server, the computer program product comprising computer program code, the computer program code comprising:
computer program code for fetching the entity identifier,
computer program code for requesting entity specific data linked to the entity identifier from the entity handling server,
computer program code for obtaining display size data,
computer program code for obtaining interaction statistics regarding the items in the set from the interaction data server,
computer program code for determining priorities of the items in the set based on the interaction statistics and the entity specific data,
computer program code for selecting a group of items from the set based on their priority settings and the size of the display, and
computer program code for presenting said group of items on the display.
